(19) United States
(12) Patent Application Publication
(10) Pub. No.: US 2007/0028789 A1
(43) Pub. Date: Feb. 8, 2007

(54) Method for operating a printing press

(75) Inventors: Peer Dilling, Friedberg (DE); Josef Schneider, Diedorf (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG

(21) Appl. No.: 11/494,191

(22) Filed: Jul. 27, 2006

(30) Foreign Application Priority Data
Aug. 2, 2005 (DE) 10 2005 036 223.0

(51) Int. Cl. B41F 33/00

(52) U.S. Cl. 101/483

(57) ABSTRACT

A method for operating a printing press for carrying out a forme change and a format change on a sleeve-based printing unit of the printing press, in which a rewritable or erasable printing sleeve is used as printing forme includes setting images on a printing sleeve outside the printing unit of the printing press, wherein the printing sleeve which has images set on it outside the printing unit is positioned on a forme cylinder of the printing unit together with a spacer sleeve which is adapted to the format to be printed, for carrying out the forme change and format change.

### BACKGROUND OF THE INVENTION

1. Field of the Invention

The invention relates to a method for operating a printing press for carrying out a forme change and a format change in sleeve based printing units.

2. Description of the Prior Art

When printing with a printing forme, a distinction is made in principle between methods that use printing formes which can be written once and methods that use rewritable printing formes. Printing methods which use rewritable printing formes are generally grouped under the keyword “computer to press/direct imaging”. The applicant markets digital printing presses under the product designation “DICOweb”, which operate with rewritable and erasable printing formes. With regard to the principles of DICOweb technology, reference can be made to “Handbuch der Printmedien [Handbook of print media], Helmut Kipphan, pages 674-680, year 2000, Springer-Verlag”.

In fixed printing formes, a distinction is made between printing plates and printing sleeves. The printing sleeves have the advantage over printing plates that they do not have to be clamped in a clamping channel of a forme cylinder. As a consequence of the absence of clamping channels, the use of printing sleeves as printing formes results in a quieter rolling behaviour of printing-press cylinders which roll on one another. A further advantage of printing sleeves lies in the fact that they are suitable for endless printing. Printing formes which are configured as printing sleeves are used in printing presses which operate according to the direct imaging principle with rewritable and erasable printing formes.

If a printing press is to be changed over to a new print job after the printing of a previous print job has ended, it is necessary for this purpose to carry out a forme change. This entails adapting the printing formes to the imaging required for the new print job. Furthermore, it may be necessary for this purpose to carry out what is known as a format change, namely when, in addition to the printing image, the printing format is also changed between two print jobs which are to be printed one after another. The present invention relates to a method for carrying out a forme change and a format change on sleeve-based printing units of a printing press, in which rewritable and erasable printing sleeves are used as printing formes.

According to the prior art, the procedure for carrying out a forme change and a format change on a printing unit of this type is for the current printing sleeve to be removed from the forme cylinder after the end of a print job. After removal of the current printing sleeve, a spacer sleeve and a new printing sleeve are positioned on the forme cylinder, the spacer sleeve and the new printing sleeve being adapted to the format to be printed of the new print job. The new printing sleeve which is positioned on the forme cylinder subsequently has images set on it within the printing unit. Furthermore, a format change must also be effected in the region of the transfer cylinder in which a rubber sleeve is positioned on the transfer cylinder with a corresponding spacer sleeve, the rubber sleeve being likewise adapted to the format of the new print job. The consequence of this known procedure is that a large number of work steps are required to carry out a forme change and a format change on a printing unit of a printing press. The large number of work steps cause a relatively long changeover time on the printing press, during which time the printing press is not available for printing. This is disadvantageous, in particular, for cost reasons.

### SUMMARY OF THE INVENTION

An object of the present invention is to provide a new procedure for effecting a forme change and format change in a printing press.

The object is met by a method for carrying out a forme change and a format change on a sleeve-based printing unit of a printing press in which a rewritable or erasable printing sleeve is used as printing forme, including the steps of setting images on a printing sleeve at a position outside the printing unit of the printing press for a subsequent print job, wherein the printing sleeve which has images set on it outside the printing unit is positioned on a forme cylinder of the printing unit together with a spacer sleeve which is adapted to the format to be printed for the subsequent print job.

Changeover times on a printing press for carrying out a forme change and a format change can be reduced considerably using the method according to the invention. As a result, a printing press is available for printing for a longer time, with the result that hourly rates of a printing press can be utilized better.

According to one embodiment of the invention, the printing sleeve which is to have images set on it outside the printing unit is already positioned on an adapted spacer sleeve for image setting, with the result that the printing sleeve can be positioned on the forme cylinder of the printing unit together with the spacer sleeve directly after image setting.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### DETAILED DESCRIPTION OF THE PREFERRED EMBODIMENTS

The invention relates to a method for operating a printing press, in particular a web-fed rotary press, namely for carrying out a forme change and a format change on at least one printing unit of the printing press. It is to be assumed in the following text that the printing units of the printing press are sleeve-based and operate with rewritable and erasable printing sleeves. Printing units which operate with rewritable and erasable printing sleeves are also called “computer to press/direct imaging” printing units or direct image setting printing units.

In order to carry out a format change on a sleeve-based printing unit of this type of a printing press, images are set on a printing sleeve at a position outside the printing unit of the printing press for a subsequent print job during the time within which the printing press prints a previous print job, which printing sleeve is subsequently used for carrying out the forme change and format change on a printing unit. Accordingly, the printing sleeve has images set on it in a decoupled manner from printing operation of the printing press, preferably in the immediate vicinity of the printing press.

If the previous print job is then ended, a forme change and a format change are carried out to change over a printing unit of the printing press for the subsequent or new print job, such that the printing sleeve which has images set on it outside the printing unit is positioned on the forme cylinder of the printing unit together with a spacer sleeve which is adapted to the format to be printed of the new print job.

Furthermore, a corresponding format change is also carried out in the region of the transfer cylinder of the printing unit, a spacer sleeve which is likewise adapted to the format to be printed of the new print job being arranged on the transfer cylinder, on which spacer sleeve a corresponding rubber sleeve is positioned.

According to a preferred embodiment of the present invention, the printing sleeve which is to have images set on it outside the printing unit is already positioned on a spacer sleeve which is adapted to the format to be printed of the new print job for image setting, with the result that the printing sleeve which has had images set on it can be positioned on the forme cylinder of the respective printing unit together with the spacer sleeve directly after image setting. As a result, it is then possible to carry out the forme change and the format change particularly quickly.

As an alternative, the printing sleeve which is to have images set on it may be positioned outside the printing units on a cylinder or core cylinder for image setting and, after image setting, then arranged on a spacer sleeve which is adapted to the format of the new print job. After the printing sleeve which has images set on it has been re-positioned from the core cylinder onto the spacer sleeve, the printing sleeve can then be positioned on a forme cylinder of the respective printing unit for carrying out a forme change and a format change.

A reduction in changeover times on a printing press can be achieved in every case with the method according to the invention. The changeover time on a printing press is limited to just the changing of the sleeves, the image setting being carried out outside the printing units. As a result of the fact that the printing sleeves are positioned on the forme cylinders of the printing units together with spacer sleeves, the handling of the printing sleeves is simplified, as the spacer sleeves impart increased stability to the printing sleeves.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for operating a printing press for carrying out a forme change and a format change on a sleeve-based printing unit of the printing press in which a rewritable or erasable printing sleeve is used as a printing forme, the method comprising the steps of:
setting images for a subsequent print job on a printing sleeve at a position outside of the printing unit of the printing press; and
positioning the printing sleeve on a forme cylinder of the printing unit together with a spacer sleeve which is adapted to the format of the subsequent print job, for carrying out the forme change and format change.

2. The method of claim 1, wherein said step of setting images is performed during printing operation of a previous print job of the printing press.

3. The method of claim 1, wherein the printing sleeve which is to have images set on it outside the printing unit is positioned on an adapted spacer sleeve when said step of setting is performed, whereby the printing sleeve is positionable on the forme cylinder of the printing unit together with the spacer sleeve directly after said step of setting.

4. The method of claim 1, wherein the printing sleeve which is to have images set on it outside the printing unit is positioned on a cylinder when said step of setting is performed, said method further comprising the step of arranging the printing sleeve on an adapted spacer sleeve after said step of setting, whereby the printing sleeve is positionable on the forme cylinder of the printing unit together with the spacer sleeve directly after said step of arranging.

5. The method of claim 1, further comprising the steps of removing a printing sleeve of the previous print job which has ended from the forme cylinder of the printing unit and subsequently positioning the printing sleeve which has images set on it outside the printing unit for a new print job on the forme cylinder of the printing unit together with a spacer sleeve adapted to the format of the subsequent print job.

6. The method of claim 5, wherein said step of removing further comprising removing a spacer sleeve which is adapted to the previous print job.

7. The method of claim 1, further comprising the step of effecting a format change on a transfer cylinder of the printing unit by arranging a spacer sleeve adapted to the format of the subsequent print job between the transfer cylinder and a rubber sleeve.
